(19) United States
(12) Patent Application Publication
(10) Pub. No.: US 2024/0212659 A1
(43) Pub. Date: Jun. 27, 2024

(54) Pickup system for stringed instrument

(71) Applicant: Brent J. Boberg, Twin Falls, ID (US)

(72) Inventor: Brent J. Boberg, Twin Falls, ID (US)

(21) Appl. No.: 18/391,783

(22) Filed: Dec. 21, 2023

Related U.S. Application Data
(60) Provisional application No. 63/476,727, filed on Dec. 22, 2022.

(51) Int. Cl. G10H 3/18; G10H 3/08; G10H 3/10

(52) U.S. Cl. CPC G10H 3/181; G10H 3/08; G10H 3/10

(57) ABSTRACT

The pickup system for a string instrument uses a combination of a single under-string pickup, or a primary pickup, and a secondary offset pickup that is placed away from the strings. The primary pickup senses the vibrations of the strings while also picking up background noise. The secondary pickup does not pick up the vibration of the strings, only picking up the background or environmental noise. Thus, in various combinations, the secondary pickup with the primary pickup can cancel out the background noise. This cancellation occurs without creating any drag beyond that of the primary pickup.

### CROSS-REFERENCE TO RELATED APPLICATION

This application is a continuation-in-part of U.S. Pat. App. Ser. No 63/476,727, filed Dec. 22, 2022, titled Pickup system for stringed instrument.

### FIELD

This invention relates to the field of stringed instruments and more particularly to an electronic pickup system that combines the benefits of a single under-string pickup with the hum reduction of a second pickup.

### BACKGROUND

The invention of the electric guitar expanded the usability of guitars in music by allowing for the creation of a greater variety of sounds. In summary, an electric guitar uses an electromagnetic pickup to measure the vibrations of strings. The resulting signal is amplified and output to a speaker.

The detriment of an electromagnetic pickup is that background electromagnetic noise is also sensed. The result is a hum or other undesirable sound in the guitar output. This hum is commonly removed using a humbucking pickup. A humbucking pickup uses two coils with opposite magnetic polarity, canceling out the hum produced by a single coil alone.

While cancellation of the hum is desirable, having two pickups under the strings rather than one creates drawbacks such as additional magnetic drag on the strings and a loss of clarity.

What is needed is a system that combines the benefits of single and dual pickups, while reducing the detriments of each.

### SUMMARY

The pickup system for a string instrument uses a combination of a single under-string pickup, or a primary pickup, and a secondary offset pickup that is placed away from the strings.

A pickup is a device that detects the vibrations of the strings. Pickups are used within certain musical instruments, especially string instruments such as electric guitars. A pickup transforms string vibrations into an electrical signal, which can then be strengthened with an amplifier and projected through a loudspeaker as musical sound. More specifically, a pickup is a transducer that captures mechanical vibrations produced by the strings and converts them into an electrical signal for amplification. The most common types of pickups use magnets and coiled wire to sense string vibrations. The motion of the string modulates the magnetic field created by the pickup, which in turn produces an electrical current in the coiled wire, which can then be altered and amplified to create a resulting sound.

Passive pickups use magnets and wire coils to sense vibrations. Active pickups use a battery-powered preamp to boost the signal before it is amplified. While a normal pickup has a coil of wire wrapped around a magnet, active pickups may use a first coil of wire wrapped around a second coil of wire, the second coil of wire generating a magnetic field by means of an electric current from a power source such as a battery. Any of the described types of pickups can be used in the disclosed system.

Single coil pickups generally have one coil of wire wrapped around one magnet or row of magnets. The result is a 1:1 ratio of coils to magnet sets.

Humbucker pickups were designed to eliminate the 50 or 60-cycle electrical hum of single coils. The most common humbucker designs use a single magnet, with a row of unmagnetized magnetic pole pieces adjacent to each pole of the single magnet. The pole pieces extend the magnetic field, specifically to a first row on the north end of the magnet and a second row on the south end of the magnet.

Additionally, alternative single-coil sized pickups are constructed by stacking two coils together side-by-side and linking them electrically. These use one row of magnets, but two coils wired together. Further, humbucking pickups can be constructed with more than two coils. For example, three-coil humbuckers allow for tapping into partial coil combinations. The number of magnets may or may not equal the number of coils.

Returning to the pickup system for stringed instruments, the combination of a primary pickup and a secondary pickup creates benefits. The primary pickup senses the vibrations of the strings while also picking up background noise. The secondary pickup does not pick up the vibration of the strings, only picking up the background or environmental noise. Thus, the signal of the primary pickup and the signal of the secondary pickup, when combined, cancel out the electronic background noise. This cancellation occurs without creating any drag beyond that of the primary pickup. Additionally, because the signal differs at different points along the string, picking up the signal at a single point increases clarity as compared to a humbucker style pickup, which picks up the signal at two points.

In an alternative embodiment, the secondary pickup is an inductor, or series of inductors, preferably formed with a ferromagnetic core. The job of the secondary pickup is to match the sensitivity of the primary pickup to background electronic noise. One method of accomplishing this is to match the inductance, resistance, and magnetic strength, of the secondary pickup to the primary pickup. By matching the characteristics of the primary pickup, the secondary pickup senses the same background electromagnetic noise, thus being best matched to cancel out the noise in the signal of the primary pickup.

In a second alternative embodiment, the secondary pickup is not a matching pickup—in other words, in this embodiment, the secondary pickup does not necessarily include the same quantity of magnets or shape of the primary pickup. This allows the secondary pickup to be more freely placed, while still being able to sense environmental noise.

In the preferred embodiment, the primary pickup is movable, able to slide to multiple individual indexed positions, or slide to any position, under the strings. The result is that the primary pickup can create a multiplicity of differing sounds using only a single pickup. Separating the secondary pickup from the primary pickup allows for a greater range of linear motion of the single pickup while still providing the ability to filter out background electromagnetic noise.

In the preferred embodiment, the user chooses between three switch positions. The first switch position includes only the primary pickup. The second switch position includes the primary pickup and the secondary pickup in series. The third switch position includes the primary pickup and the secondary pickup in parallel.

As a related invention, substitution or addition of a capacitor with a low capacitance value in the tone circuit can create a sound that is darker than an unaltered circuit, and less mellow than a traditional tone circuit. Referred to as the “vintage tone knob,” the resulting tone circuit removes relatively high frequencies from the sound while adding a resonant peak, the resulting sound being different from a traditional tone knob that tends to make the sound darker.

In alternative embodiments, a switch is added that allows a user to choose between various values of capacitance. For example, instead of including both a tone knob and a vintage tone knob, the knobs can be combined into a single knob that selects between multiple capacitance values. Or pulling on the knob could also change the associated circuit path.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a front view of the pickup system for stringed instrument.

FIG. 2 illustrates a front view with pickguard removed of the pickup system for stringed instrument.

FIG. 3 illustrates a first detailed view with pickup guard removed of the pickup system for stringed instrument.

FIG. 4 illustrates a second detailed view with pickup guard removed of the pickup system for stringed instrument.

FIG. 5 illustrates a detailed view showing recesses in the guitar body of the pickup system for stringed instrument.

FIG. 6 illustrates a detailed view of the layout of the electronics of the pickup system for stringed instrument.

FIG. 7 illustrates a first embodiment of the electronics of the pickup system for stringed instrument.

FIG. 8 illustrates a second embodiment of the electronics of the pickup system for stringed instrument.

FIG. 9 illustrates a third embodiment of the electronics of the pickup system for stringed instrument.

FIG. 10 illustrates a fourth embodiment of the electronics of the pickup system for stringed instrument.

FIG. 11 illustrates a fifth embodiment of the electronics of the pickup system for stringed instrument.

FIG. 12 illustrates a sixth embodiment of the electronics of the pickup system for stringed instrument.

FIG. 13 illustrates a seventh embodiment of the electronics of the pickup system for stringed instrument.

FIG. 14 illustrates an embodiment of the variable indictor of the pickup system for stringed instrument.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

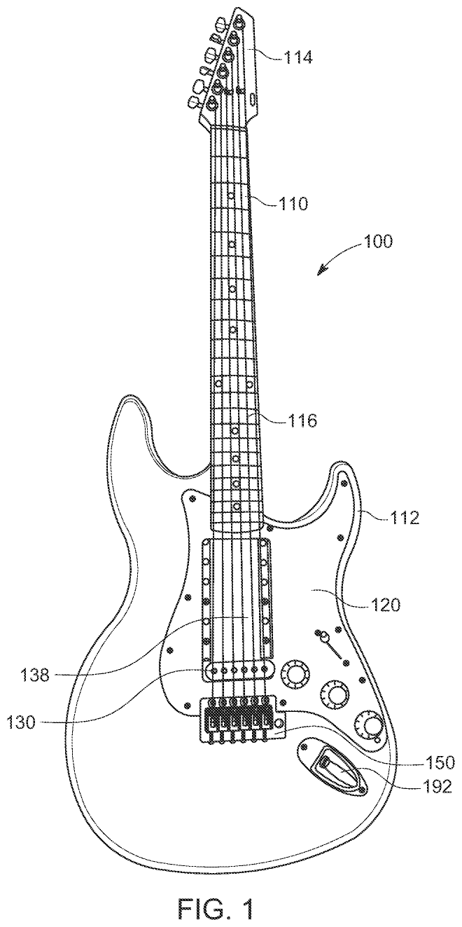

Referring to FIG. 1, a front view of the pickup system for stringed instrument is shown.

The pickup system for stringed instrument 100 is shown installed on a guitar. Parts include neck 110, body 112, head stock 114, bridge and saddles 150 with strings 116. The primary pickup 130 is shown within the primary pickup recess 138. Also shown is pickguard 120, and output jack 192.

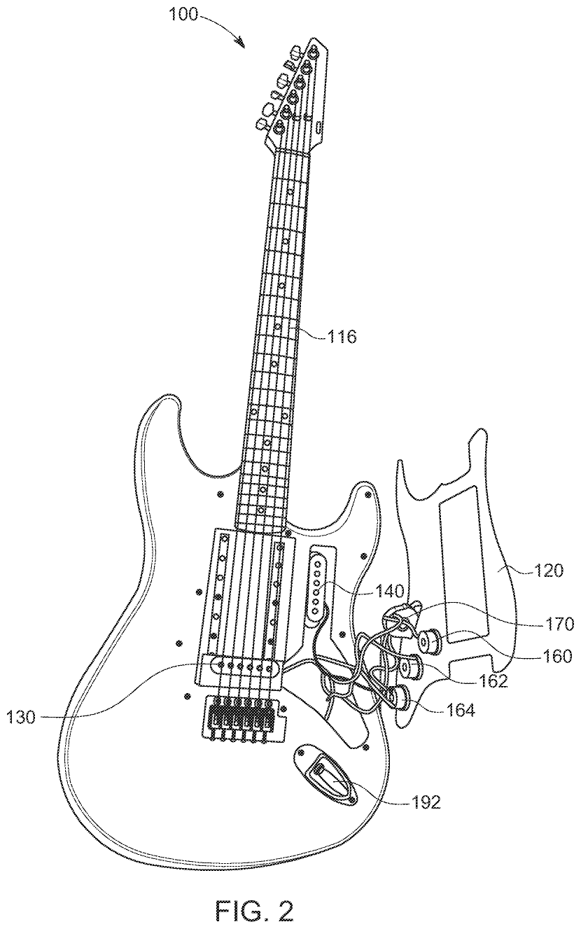

Referring to FIG. 2, a front view with pickguard removed of the pickup system for stringed instrument is shown.

Strings 116 pass across the primary pickup 130. The secondary pickup 140 is placed away from the strings 116. Also shown is first potentiometer 160, second potentiometer 162, and third potentiometer 164. The three-way switch 170 is used in conjunction with the potentiometers 160/162/164 to adjust the tone, sound, and volume of the guitar. The three-way switch 170 also controls whether the secondary pickup 140 is included in the circuit, and if so, whether it is wired in series or parallel with the primary pickup 130.

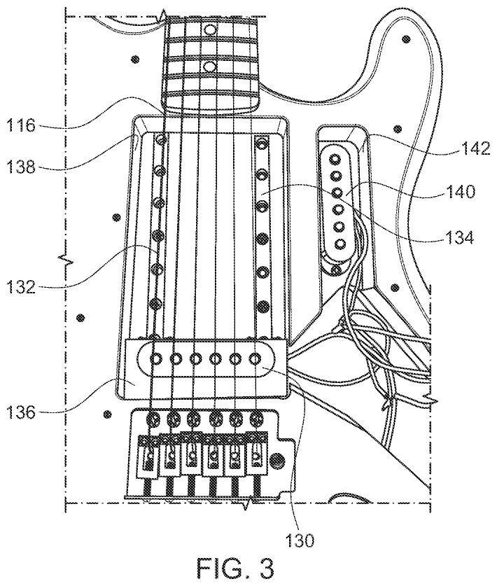

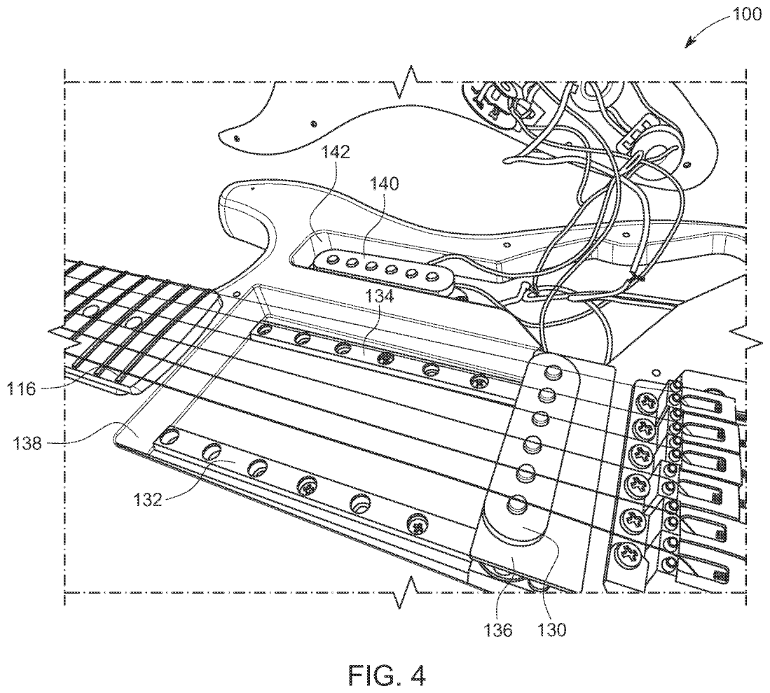

Referring to FIGS. 3 and 4, a first detailed view and a second detailed view with pickup guard removed of the pickup system for stringed instrument are shown.

The primary pickup 130 is shown placed on the primary pickup frame 136 that slides along the first rail 132 and second rail 134 within the primary pickup recess 138. The primary pickup 130 remains under the strings 116 regardless of its position along the first rail 132 and second rail 134. In contrast, the secondary pickup 140 is stationary, placed in the secondary pickup recess 142, offset from the strings 116. In the preferred embodiment, the secondary pickup 140 is placed in the same plane as the primary pickup 130.

The primary pickup 130 can be moved to any position along the first rail 132 and second rail 134, creating a variety of different pickup locations under the strings 116. In the preferred embodiment, the first rail 132 and the second rail 134 act as electrical conductors, carrying the signal of the primary pickup 130.

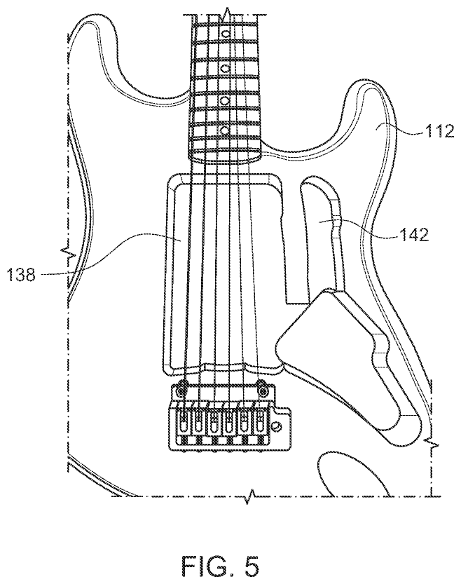

Referring to FIG. 5, a detailed view showing recesses in the guitar body of the pickup system for stringed instrument is shown.

The body 112 is shown with primary pickup recess 138 and secondary pickup recess 142.

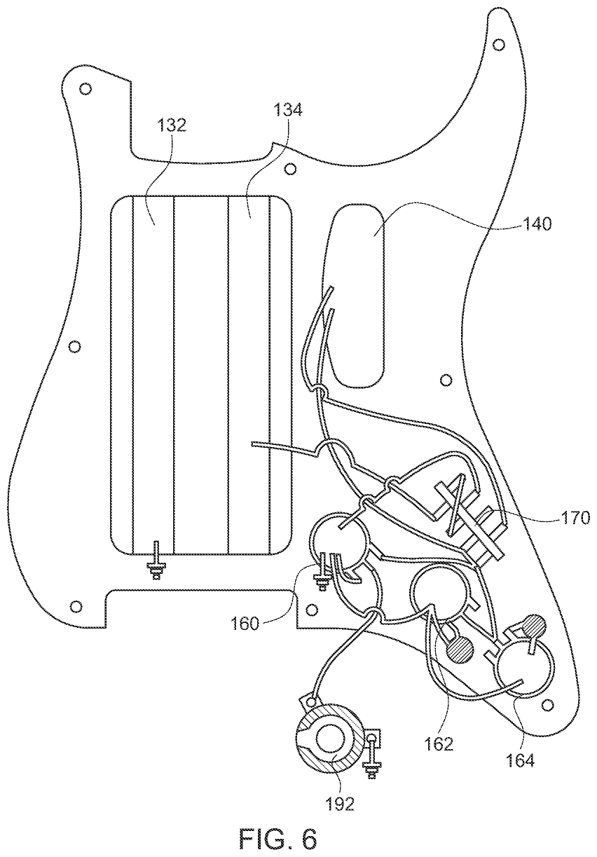

Referring to FIG. 6, a detailed view of the layout of the electronics of the pickup system for stringed instrument is shown.

The first rail 132 and the second rail 134 are shown, connected to the three-way switch 170, which is in turn connected to the first potentiometer 160, second potentiometer 162, and third potentiometer 164. Also shown is the output jack 192. The capacitor connected to the third potentiometer 164 is of a significantly lower capacitance as compared to a typical circuit, and is associated with the tone knob.

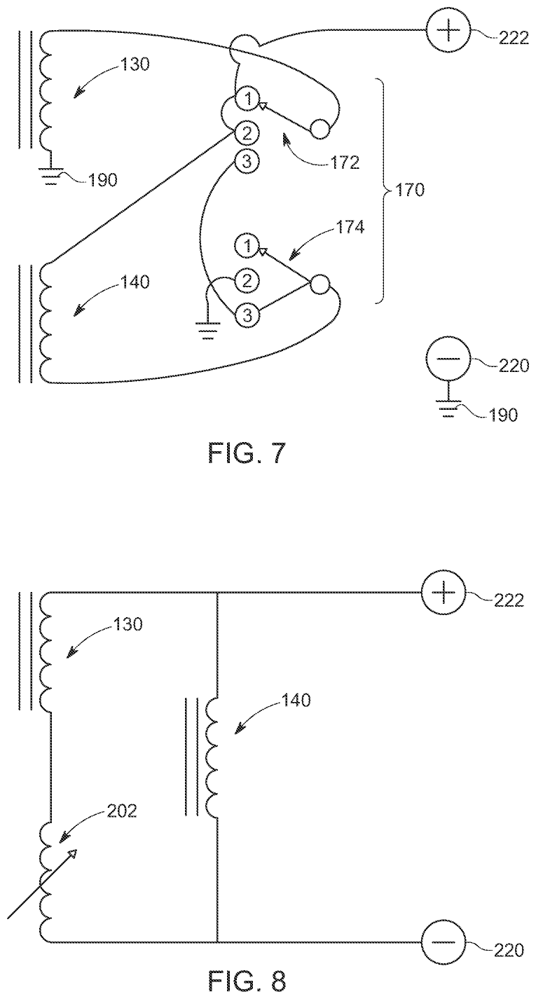

Referring to FIG. 7, a first embodiment of the electronics of the pickup system for stringed instrument is shown.

Primary pickup 130 is shown connected to signal ground 190 and to the first switch circuit 172 of the three-way switch 170. Secondary pickup 140 is shown connected to the first switch circuit 172 and the second switch circuit 174. The first switch circuit 172 and the second switch circuit 174 are part of the same physical switch, preferably a standard 3-way guitar switch.

Also shown are positive 222, and negative 220 or ground 190. In this preferred embodiment, the options for connecting the pickups are: the primary pickup 130 alone; the primary pickup 130 in conjunction with the secondary pickup 140 wired in series; or the primary pickup 130 in conjunction with the secondary pickup 140 wired in parallel.

Referring to FIG. 8, a second embodiment of the electronics of the pickup system for stringed instrument is shown.

In this embodiment, the primary pickup 130 is wired in parallel with the secondary pickup 140, a variable inductor included in series with the primary pickup 130.

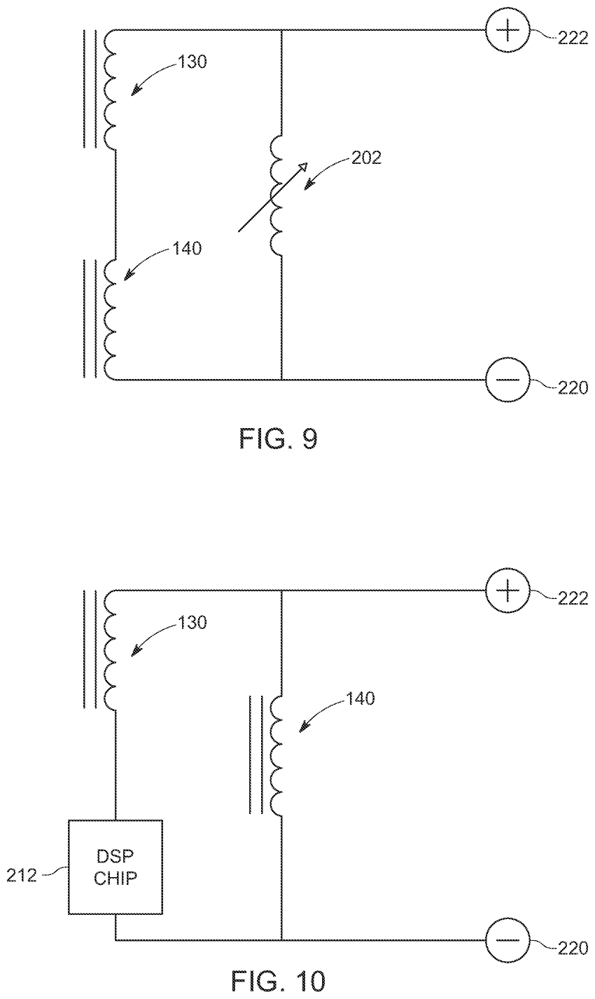

Referring to FIG. 9, a third embodiment of the electronics of the pickup system for stringed instrument is shown.

In this embodiment, the primary pickup 130 is where in series with the secondary pickup 140, which are in turn parallel with the variable inductor 202.

Referring to FIG. 10, a fourth embodiment of the electronics of the pickup system for stringed instrument is shown.

In this embodiment, the primary pickup 130 is wired in series with the DSP chip 212, the combination wired in parallel with the secondary pickup 140.

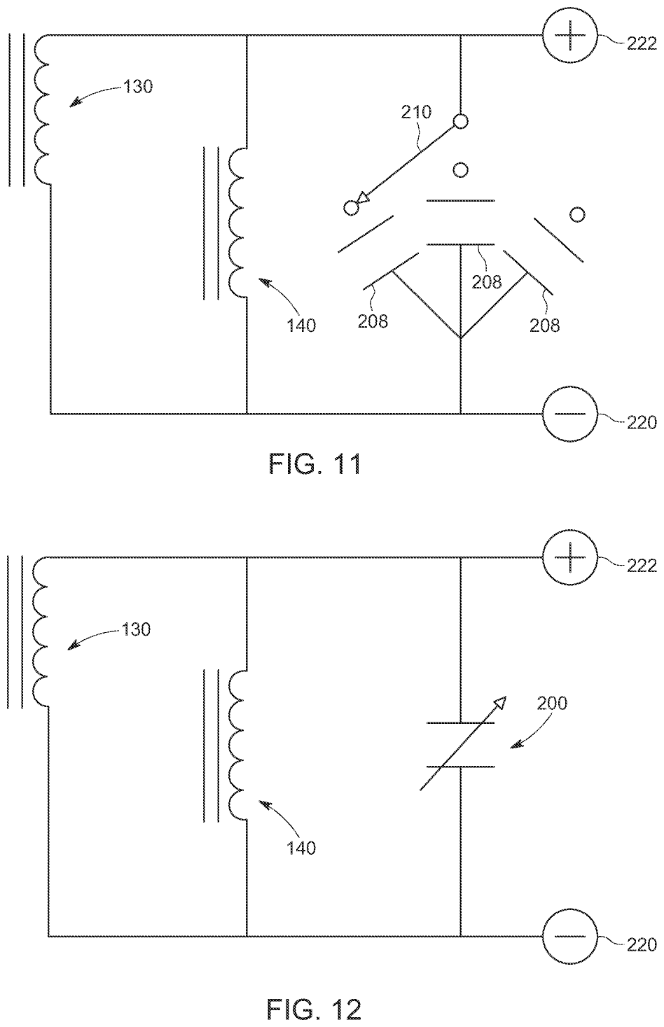

Referring to FIG. 11, a fifth embodiment of the electronics of the pickup system for stringed instrument is shown.

In this embodiment, the primary pickup 130 is wired in parallel with the secondary pickup 140, further in parallel with multiple capacitors 208 selected using a capacitor switch 210.

Referring to FIG. 12, a sixth embodiment of the electronics of the pickup system for stringed instrument is shown.

In this embodiment, the primary pickup 130 is wired in parallel with the secondary pickup 140, further in parallel with a variable capacitor 200.

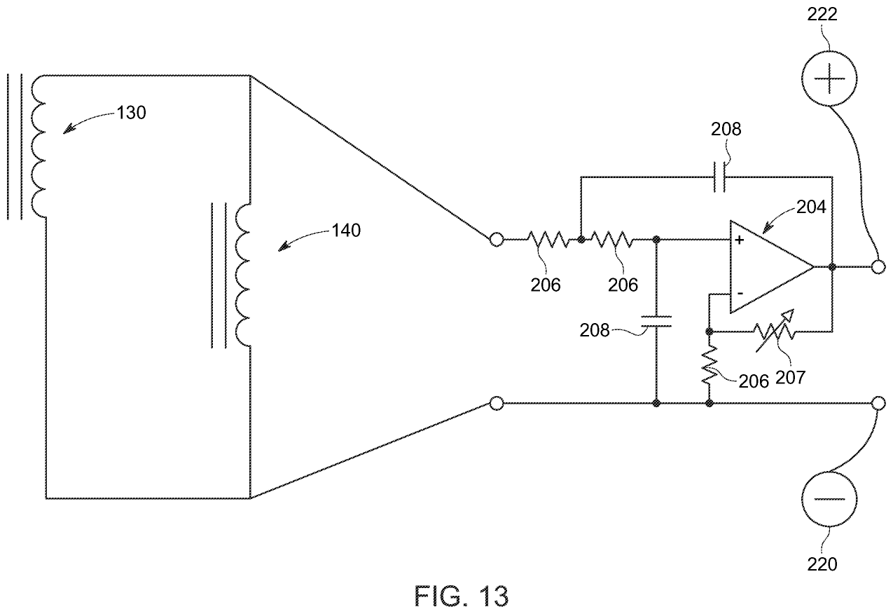

Referring to FIG. 13, a seventh embodiment of the electronics of the pickup system for stringed instrument is shown.

In this embodiment, the primary pickup 130 is wired in parallel with the secondary pickup 140, which is in turn wired in conjunction with an op amp circuit consisting of resistors 206, capacitors 208, variable resistors 207, and an op amp 204.

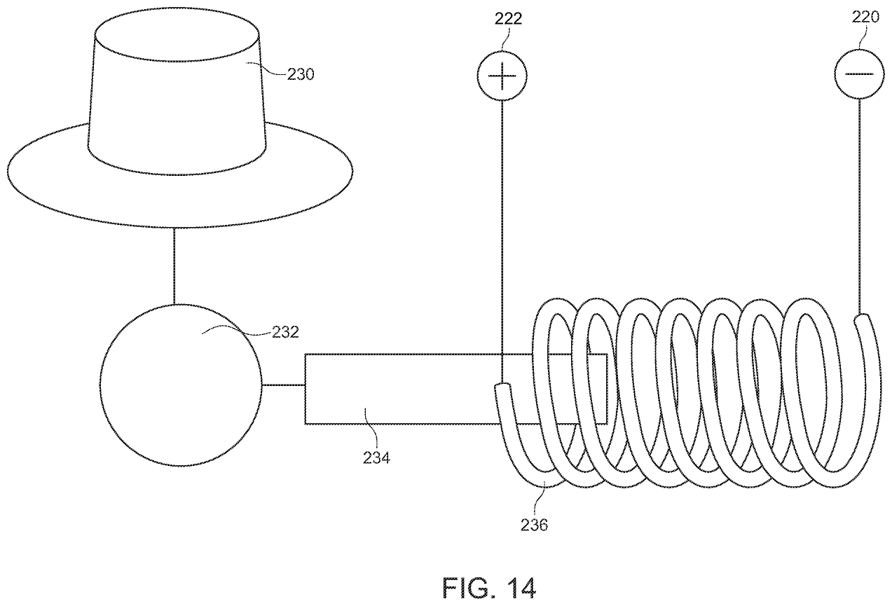

Referring to FIG. 14, an embodiment of a variable inductor for use with the pickup system for stringed instrument is shown.

The variable inductor is one possible embodiment of the variable inductor 202 (see FIG. 8 or FIG. 9).

To control the inductance, the knob 230 interfaces with a gear 232 that changes the position of the moving magnet 234 within the coil 236. With the variable inductor within the circuit, connected at negative 220 and positive 222, the changes in inductance change the resulting sound of the instrument.

Equivalent elements can be substituted for the ones set forth above such that they perform in substantially the same manner in substantially the same way for achieving substantially the same result.

What is claimed is:

1. A pickup system for a stringed instrument comprising:
a primary pickup;
the primary pickup located under one or more strings;
the primary pickup senses vibration of the one or more strings;
the primary pickup creates a primary signal;
a secondary pickup;
the secondary pickup is offset from the primary pickup, placed away from the one or more strings;
the secondary pickup does not sense vibration of the one or more strings;
the secondary pickup creates a secondary signal;
the primary pickup is wired in series or parallel with respect to the secondary pickup;
whereby a combination of the primary signal and the secondary signal removes environmental electromagnetic noise from an output signal.

2. The pickup system for a stringed instrument of claim 1, wherein:
the primary pickup can move along a length of the one or more strings;
whereby repositioning the primary pickup changes the primary signal created by motion of the one or more strings.

3. The pickup system for a stringed instrument of claim 2, further comprising:
a positive rail and a negative rail;
the primary pickup moving along the positive rail and the negative rail;
the positive rail and the negative rail carrying the primary signal of the primary pickup, regardless of position of the primary pickup;
whereby use of the positive rail and the negative rail reduces complexity of wiring for the primary pickup.

4. The pickup system of claim 1, wherein the primary pickup and the secondary pickup are wired in series.

5. The pickup system of claim 1, wherein the primary pickup and the secondary pickup are wired in parallel.

6. The pickup system of claim 1, wherein the secondary pickup comprises a humbucker pickup.

7. The pickup system of claim 1, wherein a variable inductor is wired in series with the primary pickup, and the combination of the variable inductor and the primary pickup is wired in parallel with the secondary pickup;
whereby changing the inductance value of the variable inductor changes the output signal, and therefore resulting sound, of the stringed instrument.

8. The pickup system of claim 1, wherein the primary pickup and the secondary pickup are wired in series, the combination of the primary pickup and the secondary pickup wired in parallel with a variable inductor.
whereby changing the inductance value of the variable inductor changes the output signal, and therefore resulting sound, of the stringed instrument.

9. The pickup system of claim 1, further comprising:
a capacitor circuit comprising:
a first capacitor and a second capacitor;
the first capacitor having a different capacitance than the second capacitor;
a switch for choosing an electrical path that passes through the first capacitor or the second capacitor;
the capacitor circuit wired in parallel with the primary pickup and wired in parallel with the secondary pickup;
whereby the switch changes whether the first capacitor or the second capacitor is in parallel with the primary pickup and the secondary pickup, thereby altering an output signal.

10. A pickup system for a stringed musical instrument, comprising:
a first pickup transducer configured to sense vibrations from one or more strings of the stringed musical instrument and convert the vibrations into a first electrical signal;
a second pickup transducer placed separately from the first pickup transducer in an orientation that does not detect vibrations from the one or more strings, the second pickup transducer configured to convert ambient electromagnetic noise into a second electrical signal;
wherein the first pickup transducer and the second pickup transducer are electrically connected, allowing the second electrical signal to subtract ambient electromagnetic noise from the first electrical signal;
thereby producing an output signal containing string vibration components with reduced electromagnetic noise.

11. The pickup system for a stringed musical instrument of claim 10, wherein:
the first pickup transducer can move along a length of the one or more strings;
whereby repositioning the first pickup transducer changes the first electrical signal created by motion of the one or more strings.

12. The pickup system for a stringed musical instrument of claim 11, further comprising:
a positive rail and a negative rail;
the first pickup transducer moving along the positive rail and the negative rail;
the positive rail and the negative rail carrying the first electrical signal of the first pickup transducer, regardless of position of the first pickup transducer;
whereby use of the positive rail and the negative rail reduces complexity of wiring for the first pickup transducer.

13. The pickup system for a stringed musical instrument of claim 10, wherein the first pickup transducer and the second pickup transducer are wired in series.

14. The pickup system for a stringed musical instrument of claim 10, wherein the first pickup transducer and the second pickup transducer are wired in parallel.

15. The pickup system for a stringed musical instrument of claim 10, wherein a variable inductor is wired in series with the first pickup transducer, and a combination of the variable inductor and the first pickup transducer is wired in parallel with the second pickup transducer;
whereby changing the inductance value of the variable inductor changes the output signal, and therefore resulting sound, of the stringed musical instrument.

16. The pickup system for a stringed musical instrument of claim 10, wherein the first pickup transducer and the second pickup transducer are wired in series, a combination of the first pickup transducer and the second pickup transducer wired in parallel with a variable inductor.
whereby changing the inductance value of the variable inductor changes the output signal, and therefore resulting sound, of the stringed musical instrument.

17. The pickup system for a stringed musical instrument of claim 10, further comprising:
a capacitor circuit comprising:
a first capacitor and a second capacitor;
the first capacitor having a different capacitance than the second capacitor;
a switch for choosing an electrical path that passes through the first capacitor or the second capacitor;
the capacitor circuit wired in parallel with the first pickup transducer and the second pickup transducer;
whereby the switch changes whether the first capacitor or the second capacitor is in parallel with the first pickup transducer and the second pickup transducer, thereby altering an output signal.

18. The pickup system for a stringed musical instrument of claim 10, wherein the first pickup transducer comprises a single-coil pickup positioned below one or more guitar strings.

19. The pickup system for a stringed musical instrument of claim 10, further comprising: a preamplifier circuit configured to process and combine the first electrical signal from the first pickup transducer and the second electrical signal from the second pickup transducer prior to output.

20. A system for sensing vibrations of strings of a stringed instrument, while removing environmental noise, comprising:
a primary pickup and a secondary pickup;
the primary pickup located under the strings of the stringed instrument;
the primary pickup sensing vibrations of the strings and sensing environmental noise;
the primary pickup outputting a primary electrical signal;
the primary pickup able to be placed at a multiplicity of positions under the strings of the stringed instrument;
the secondary pickup not located under the strings of the stringed instrument;
the secondary pickup sensing only environmental noise;
the secondary pickup outputting a secondary electrical signal;
a positive rail and a negative rail;
the primary pickup moving along the positive rail and the negative rail;
the positive rail and the negative rail carrying the primary electrical signal of the primary pickup, regardless of position of the primary pickup;
wherein the primary pickup and the secondary pickup wired in series or parallel, a combination of which cancels out environmental noise.
